(19) United States
(12) Patent Application Publication
(10) Pub. No.: US 2026/0338741 A1
(43) Pub. Date: Oct. 29, 2026

(54) System and Method of Carbon Dioxide and Water Removal Prior to Chemical Analysis

(71) Applicant: Entech Instruments Inc., Simi Valley, CA (US)

(72) Inventor: Daniel B. CARDIN, Simi Valley, CA (US)

(21) Appl. No.: 19/662,878

(22) Filed: Apr. 29, 2026

Related U.S. Application Data
(60) Provisional application No. 63/796,604, filed on Apr. 29, 2025.

(51) Int. Cl. G01N 30/14; G01N 30/12; G01N 30/20; G01N 30/30; G01N 30/02; G01N 30/06

(52) U.S. Cl. CPC G01N 30/14; G01N 30/12; G01N 30/20; G01N 30/30; G01N 2030/025; G01N 2030/065; G01N 2030/123; G01N 2030/143

(57) ABSTRACT

A system and method analyze gas samples containing a wide range of volatile compounds in the presence of high concentrations of carbon dioxide (CO₂) and water. The system includes a first primary trap and a second primary trap arranged in series, a water knockout trap, and a focusing trap managed by a control system and a series of valves. A gas sample is introduced into the primary traps and CO₂ is frozen on the first primary trap, while more volatile compounds are captured by the second primary trap. The method involves transferring the more volatile compounds from the second primary trap to the focusing trap, heating the first primary trap to sublimate and vent the CO₂, and transferring the remaining heavier compounds from the primary traps to the focusing trap. All target compounds consolidated on the focusing trap are desorbed into a gas chromatograph for analysis.

### CROSS-REFERENCE TO RELATED APPLICATION

This application claims the benefit of U.S. Provisional Patent Application No. 63/796,604, filed on Apr. 29, 2025, the entire disclosure of which is incorporated herein by reference in its entirety for all purposes.

### FIELD OF THE DISCLOSURE

This disclosure relates generally to a system and method for the preconcentration of gas samples for analysis by gas chromatography (GC) or gas chromatography-mass spectrometry (GCMS).

### BACKGROUND OF THE DISCLOSURE

Preconcentration systems used to prepare trace level samples for GC or GCMS analysis are used to collect a large volume of gas phase sample to enrich the compounds of interest to allow their detection by the GC detector at levels much lower than possible without pre-enrichment. Most GC/GCMS is currently performed using capillary GC columns with flow rates typically from 0.5 to 2cc/min. Normal peak widths in a capillary GC run are 3-6 seconds wide. Therefore, the optimum injection time must be about 6 seconds or less when analyzing volatile chemicals that will not further focus when delivered onto a GC column. At a flow rate of 1cc/min, a 6 second injection would require that the sample be limited to a 0.1cc volume or less. However, in order to reach sub-PPB levels of detection by GCMS, a sample volume of 100cc or more is typically required. Therefore, 100-500cc of sample must be reduced to a volume of 0.1cc or less prior to injection, which would offer an enrichment of 1000 to 5000 times in this example. Typically, the enrichment of target compounds means eliminating the compounds that are of no importance, and/or would otherwise interfere with both the ability to decrease the sample volume down to 0.1cc, or would degrade the performance of the GC/GCMS. In most applications, finding a solution to eliminate the bulk constituents in air without loss of target compounds of interest is possible by finding a combination of sorbents (adsorbents) which when operated at specific temperatures allows the removal of N2, O2, Ar, and CO2 without loss of compounds of interest. The final bulk constituent, water, can be removed by using one of many dehydration techniques (Cold Dehydration Trap, Chemical Dehydration Trap, Dry Purging, others), or by first condensing all compounds of interest including the water, and then purging the compounds of interest on to a secondary trap while leaving most of the water condensed in the first stage. This works because water is often millions of times higher in concentration than the compounds of interest during trace chemical analysis, so post-water-knockout purge volumes can be chosen to bring all compounds of interest back into the gas phase while falling well short of volatilizing all of the condensed water, thereby successfully eliminating the excess water and its effect on the GCMS analyzer.

Although N2, O2, and Ar can be removed through a cold sorbent bed without loss of virtually all compounds of interest, Carbon Dioxide (CO₂) has been problematic with the analysis of many light boiling compounds. CO₂ has its triple point at -78 °C, whereby it can exist as a solid, liquid, or gas. Some greenhouse gases and Per-Fluorinated Alky Substances (PFAS) boil even lower than this, and many cannot be trapped and retained on any known sorbent at any temperature that allows removal of CO₂ during the preconcentration process, for example CH₄, CF₄, NF₃, and others. Various preconcentration systems used for greenhouse gas measurements down to sub-part per trillion levels (sub-ppt) actually measure CO₂ concentrations along with many Fluorine and Chlorine containing compounds, but these systems use multiple columns and non-MS detectors, along with PLOT or even packed columns to handle the higher amounts of CO₂ relative to the other trace gases.

US EPA Method OTM-50 as introduced at the end of 2023 has 30 compounds that are either PFAS (Per-Fluorinated Alkyl Substances) or VFCs (Volatile Fluorinated Compounds), with boiling points ranging from -128 °C (CF₄) to about 100 °C. OTM-50 is a stack gas sampling method where CO₂ levels are expected to be from 0.5-12% in the final collected gas phase samples. No combination of sorbents at any temperature have been found that retains CF₄ while allowing CO₂ to pass through, so the initial draft release of Method OTM-50 required 2 separate analyses; one to quantify CF₄ where CO₂ was not first removed, and a second for the remaining twenty-nine less-volatile OTM-50 compounds, whereby the CO₂ could be removed from the trapping media prior to the loss of those compounds. CF₄ elutes prior to the very large CO₂ peak using the GC column selected for OTM-50, , thereby avoiding any interferences, so removal of CO₂ is not necessary when only CF₄ is to be analyzed. However, this first release of OTM-50 was limited to only a volume of 20cc, due to multiple factors, so CF₄ response was 10x lower than optimal. When analyzing the rest of the compounds on the OTM-50 list using the desired 200cc sample volume, the CO₂ must be removed both due to expansion whereby the 0.1cc optimal injection volume is not achieved, and because co-elution with some of the target compounds results in up to 100% loss of signal in the detector (mass spectrometer). Again, the initial solution listed in US EPA Method OTM-50 had difficulty when CO₂ levels reached 2-4%, even when performing two separate analyses.

### SUMMARY OF THE DISCLOSURE

The present disclosure provides a system and method for the preconcentration of gas samples for analysis by gas chromatography (GC) or gas chromatography-mass spectrometry (GCMS). The present disclosure is particularly directed to solving the technical problem of analyzing samples that contain high concentrations of interfering substances, such as carbon dioxide (CO2) and water, along with a wide range of target volatile compounds, from ultralight to heavy. The disclosure enables the quantitative recovery and analysis of all target compounds in a single analytical run by effectively removing these interferents.

Some aspects of the disclosure are directed to a multi-stage trapping system. The system includes at least two primary traps arranged in series, each containing sorbent material and capable of being independently heated and cooled. Alternatively, in some embodiments, the system includes a primary trap having multiple sorbent beds, including at least two sorbent beds that are independently heated and cooled with respect to each other. The system further includes a focusing trap, which serves to concentrate the purified sample, and a dedicated water knockout trap, positioned to remove moisture from the sample stream before final concentration. Sample preparation is controlled by a control system, a network of switching valves, and heaters that manage the temperature of each trap and direct the gas flow through different pathways during the various stages of sample preparation.

Some aspects of the disclosure are directed to a method that leverages the physical properties of CO₂ to achieve its separation from analytes of the sample. A gas sample is first passed through the two primary traps, which are held at a cryogenic temperature low enough to cause the CO₂ to freeze into a solid on the first primary trap. This step immobilizes the CO₂ while allowing more volatile ("ultralight") compounds to pass through the primary trap and be captured by the second primary trap. Target compounds with higher boiling points are retained along with the frozen CO₂ on the first trap.

Next, the ultralight compounds are thermally desorbed from the second primary trap and transferred to the focusing trap while leaving CO₂ frozen on the first primary trap. After forward transfer of the ultralight compounds to the focusing trap, the first primary trap is warmed to a temperature that causes the frozen CO₂ to sublimate into a gas, which is then forward purged through the primary trap(s) and vented from the system. Finally, the remaining heavier compounds are desorbed while backflushing off the primary traps and transferred, via the water knockout trap, to the same focusing trap. The result is that all target compounds, both light and heavy, are consolidated on the focusing trap, while the interfering CO₂ and water have been effectively removed. This clean, highly concentrated sample is then rapidly desorbed from the focusing trap and injected into the gas chromatograph for trace-level analysis. This approach provides significant advantages in terms of analytical accuracy, sensitivity, and efficiency.

### BRIEF DESCRIPTION OF THE DRAWINGS

FIG. 1 illustrates a schematic diagram of an example 4-stage trapping system, which is configured for the preconcentration and analysis of chemical samples.

FIG. 2 is a flowchart illustrating an example method for chemical analysis that is performed by the trapping system shown in FIG. 1.

### DETAILED DESCRIPTION

In the following description, reference is made to the accompanying drawings which form a part hereof, and in which it is shown by way of illustration specific examples that can be practiced. It is to be understood that other examples can be used, and structural changes can be made without departing from the scope of the examples of the disclosure.

The present disclosure addresses the significant technical challenge of accurately analyzing gas samples that contain a wide range of volatile compounds, particularly when high concentrations of interfering substances like carbon dioxide (CO₂) and water are present. Conventional preconcentration methods for gas chromatography-mass spectrometry (GCMS) are often compromised by CO₂ and water, which can co-elute with target analytes, suppress detector signals, and necessitate multiple, inefficient analytical runs to capture the full spectrum of compounds. The system and method described herein overcome these limitations through a multi-stage trapping approach that provides substantial technical advantages. By utilizing two primary traps in series at a temperature sufficient to freeze CO₂ into a solid phase on the first trap, the system effectively isolates and removes CO₂ without losing the most volatile target compounds which can be retained using the second primary trap. Furthermore, a dedicated water knockout trap efficiently removes moisture from the sample stream prior to injection into the GCMS. This strategic, sequential removal of interferents enables the quantitative recovery and analysis of the entire range of target compounds in a single run. By consolidating the purified analytes onto a final focusing trap for sharp, rapid injection, the system achieves enhanced sensitivity, improved chromatographic resolution, and provides more accurate and reliable results by eliminating the analytical issues caused by CO₂ and water.

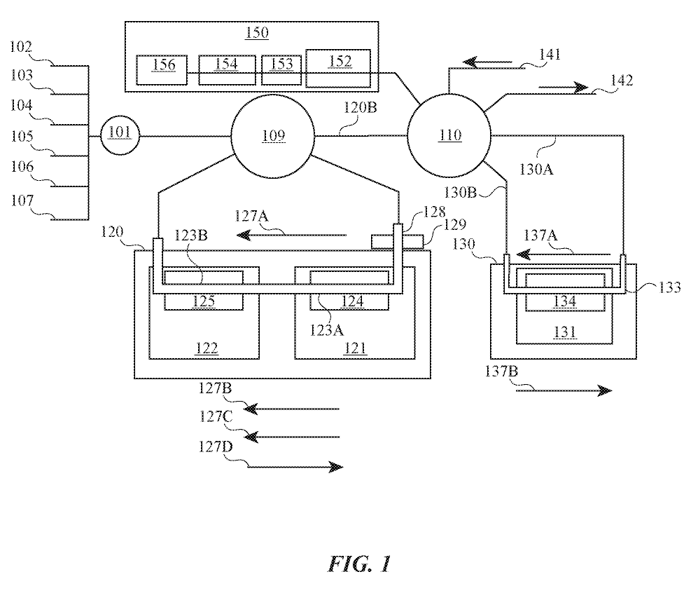

FIG. 1 illustrates a schematic diagram of an example 4-stage trapping system 100, which is configured for the preconcentration and analysis of chemical samples. The system is particularly designed to remove interfering substances such as carbon dioxide (CO₂) and water prior to analysis by a gas chromatograph (GC) or gas chromatograph-mass spectrometer (GCMS).

The system 100 includes a gas sample introduction valve 101. This valve serves as the entry point for various gas streams and is configured with multiple selectable inlets. Structurally, this is a multi-port selection valve, such as a rotary valve, which allows for the automated and sequential introduction of various gases. These inlets may include an inlet for a sample 102, an internal standard 103, surrogates 104, a calibration standard 105, a purge gas 106, and one or more inlets 107 for autosamplers. The introduction valve 101 allows a user or an automated sequence to select the appropriate gas stream for introduction into the trapping system.

Switching valve 109 is fluidly connected to the gas sample introduction valve 101, primary trapping module 120, and switching valve 110. Switching valve 110 also connects to focusing trap module 130, carrier gas 141, and a gas flow path 142 to a GCMS. Valves 109 and 110 control gas flow throughout the system 100. For example, valves 109 and/or 110 are rotary valves. The switching valves 109 and 110 direct the flow of gas between the various traps and subsystems, enabling the operations of the analysis method.

The system 100 features a primary trapping module 120, which includes a first primary trap 123A and a second primary trap 123B arranged in series. Primary traps 123A and 123B include tubes packed with sorbent. The sorbent in the first trap 123A is selected to be weaker than the sorbent in the second trap 123B, thereby enabling the initial separation of compounds and removal of CO₂. These traps are housed within one or more cold trapping zones, such as first cold zone 121 and second cold zone 122, which provide precise cryogenic cooling to temperatures of -110° C or lower. Each primary trap 123A and 123Bis equipped with its own respective heater, 124 and 125, allowing for independent heating and temperature control of each trap. Alternatively, in some embodiments, primary trapping module 120 includes a single tube packed with multiple sorbent beds corresponding to the sorbent beds described herein with respect to primary traps 123A and 123B, respectively. In these embodiments, the portions of the tube having different sorbents are equipped with their own heaters 124 and 125. This independent control enables sequential release of different compound fractions from primary traps 123A and 123B or from different portions of a multi-sorbent primary trap. These heaters can be in direct thermal contact with the trap tubes, allowing for rapid and independent heating for desorption of the primary traps 123A and 123B. The primary trapping module 120 has an inlet 120A and an outlet 120B to direct the sample flow.

A water knockout trap 128, equipped with a dedicated heater 129, is positioned within the flow path of the system. Water knockout trap 128 can be an empty or lightly packed tube designed to be cooled to a moderate temperature (e.g., -10° C to -30° C). Alternatively, the water knockout trap 128 can be an extension of the primary trapping module 120, either empty or containing a weak sorbent to provide additional surface area to ensure efficient water elimination from the gas phase. The water knockout trap 128 condenses and removes water vapor from the sample stream during heated backflushing of the primary traps, before the target compounds reach the focusing trap 133, thereby preventing water from interfering with the final GC analysis. Water knockout trap 128 does not retain target compounds, allowing the target compounds to pass to the focusing trap module 130. A dedicated heater 129 is thermally coupled to the trap 128 to vaporize and clear the collected water during a bake-out cycle. For example, heater 129 is pulsed to maintain a method-defined temperature of water knockout trap 128, such as -20 °C, and then is heated to a higher temperature during system bakeout, such as 130 ⁰C to eliminate the condensed water.

A focusing trap module 130 contains a focusing trap 133 and its associated heater 134 and cryogenic cooling system 131. The focusing trap 133 is a narrow-bore trap including an uncoated or lightly coated tube. The focusing trap 133 is configured to receive all target compounds from the primary traps 123A and 123B and concentrate them into a reduced volume. This concentration enables a sharp, rapid injection into the GC, which improves chromatographic resolution and sensitivity. Heater 134 heats the focusing trap 133 to desorb target compounds rapidly, creating a sharp injection band for high-resolution separation in the GC.

The system 100 also includes a gas volume measurement system 150, which includes a reservoir 152, an isolation valve 153, a pump 154 and a vent 156. Isolation valve 153 connects reservoir 152 and pump 154. The volume measurement system 150 can further include a pressure sensor attached to the reservoir 152 to measure the pressure in reservoir 152. The gas volume measurement system 150 serves multiple purposes: it measures the initial volume of the gas sample and standards by quantifying the fixed gases (e.g., nitrogen, oxygen) that are not retained by the primary traps 123A and 123B, measures purge volume, provides an exhaust path for venting the removed CO₂ later in the process, measures backflush volume to purge compounds remaining on the primary traps 123A and 123B to the focusing trap 133, and measures the flow of bakeout gas during trap cleanup.

The switching valve 110 also manages the interface with a gas chromatograph. It controls the introduction of GC carrier gas 141 from an inlet and directs the final, concentrated sample via the gas flow path 142 to the GC for separation and detection.

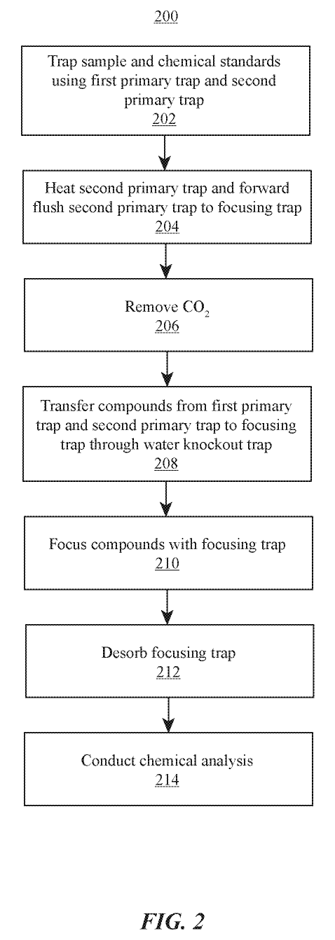

The various labeled flow paths shown in FIG. 1, such as flow paths 127A through 127D, 137A and 137B, represent the different operational stages of the analysis method. These distinct flow paths are established by changing the configuration of the switching valves 109 and 110 to connect the system components in the required sequence. These flow paths are described in more detail with reference to FIG. 2.

FIG. 2 is a flowchart illustrating an example method 200 for chemical analysis that is performed by the trapping system 100 shown in FIG. 1. The method is designed to preconcentrate a full range of target compounds from a gas sample while sequentially removing interfering substances, namely carbon dioxide (CO₂) and water, prior to final analysis.

The method 200 includes trapping 202 the sample and chemical standards using the first primary trap 123A and the second primary trap 123B. The gas sample 102 is introduced into the system 100 via the gas sample introduction valve 101 in the direction indicated by flow path 127A. The switching valve 109 is configured to direct the sample flow through the primary trapping module 120 in direction of flow path 127A, while valve 110 is configured to bypass module 130, coupling the flow from primary trapping module 120 to gas volume measurement system 150. The sample first passes through the first primary trap 123A and then compounds not retained by the first primary trap 123A enter the second primary trap 123B. During this process, the cold trapping zones 121 and 122 maintain both primary traps 123Aand 123B at a cryogenic temperature, such as -110° C or below (e.g., as low as -170° C), which is sufficient to cause CO₂ to freeze and deposit as a solid onto the sorbent material within the first primary trap 123A. CO₂ is retained by first primary trap 123A and does not enter the second primary trap 123B. Less volatile compounds are also retained on the first primary trap 123A. More volatile compounds pass through the first primary trap 123A and are captured by the stronger sorbent in the second primary trap 123B. Fixed gases that are not retained by either trap, such as nitrogen and oxygen, pass through the outlet 120B to the gas volume measurement system 150 and are measured to determine the total sample volume.

Method 200 includes heating the second primary trap 123B and forward flushing 204 the second primary trap 123B towards the focusing trap 133. The switching valve 109 reconfigures the flow path to isolate the primary traps 123Aand 123B from the sample inlet and connect the outlet of the primary trapping module 120 to the focusing trap 133 (as indicated by flow path 127B). The heater 125 is activated to warm the second primary trap 123B, releasing the trapped ultralight compounds. A purge gas 106 selected at valve 101 is used to flush these compounds forward, out of the primary trapping module 120, and onto the cryogenically cooled focusing trap 133. Throughout this operation, the first primary trap 123A remains cold, ensuring that the frozen CO₂ and the heavier compounds remain immobilized on first primary trap 123A.

Method 200 includes removing 206 the CO₂. The switching valve 110 changes configuration to isolate the focusing trap module 130, allowing the primary trapping module 120 to connect directly to the volume measurement system 150, bypassing the focusing trap module 130 while leaving primary trapping module 120 in the same forward flow direction as flow path 127C. The heater 124 is then activated to warm the first primary trap 123A to a temperature sufficient to cause the solid CO₂ to sublimate into a gas (e.g., -60° C to -80° C). This gaseous CO₂ is then forward-flushed through primary traps 123A and 123B vented from the system via the vacuum reservoir, pump 154, and vent 156. The second primary trap 123B is maintained at a temperature that is warm enough to purge the CO₂ through the stronger sorbent in second primary trap 123B while completely retaining less volatile compounds, for example 10 to -60 ⁰ C.

Method 200 includes transferring 208 compounds from the primary traps 123A and 123B to the focusing trap 133 through water knockout trap 128. The switching valve 109 establishes a back-flush flow path (as indicated by 127D), directing a purge gas 106 to enter the primary trapping module 120 at its outlet 120B and exit at its inlet 120A. Both heaters 124 and 125 are activated to fully desorb the heavier compounds from both primary traps 123A and 123B. This desorbed gas stream is directed through the water knockout trap 128, which is maintained at a moderately cold temperature (e.g., -10° C to -30° C) to condense and remove water vapor. The now dry stream of less volatile compounds then continues to the focusing trap 133, where it is collected along with the ultralight compounds, which were retained by focusing trap 133 during transfer 208 of less volatile compounds from the primary traps 123A and 123B to the focusing trap 133.

Method 200 includes focusing 210 all target compounds. All target analytes from the original sample are now trapped and consolidated in a highly concentrated band on the cryogenically cooled focusing trap 133, with CO₂ having been removed from the system 100 and water being retained by water knockout trap 128.

Method 200 includes desorbing 212 the focusing trap 133. The switching valve 110 aligns the focusing trap 133 with the GC carrier gas 141 and the GC inlet path 142. The heater 134 rapidly heats the focusing trap 133, causing the concentrated band of analytes to vaporize. The GC carrier gas 141 then sweeps the analytes into the GC using flow path 137B. Alternatively, heater 134 can preheat trap 133 prior to configuring valve 110 to bring carrier gas 141 inline with trap 133 to obtain a faster release rate of chemicals into gas flow path 142 and to the GCMS, thereby improving chromatographic resolution of chemicals to improve quantitative accuracy.

Method 200 includes conducting 214 chemical analysis. Target compounds eluted from the focusing trap 133 undergo chromatographic separation using a GC column and subsequent detection using a detector, such as an MS, completing the analysis.

This disclosed techniques are used to analyze any gas (ambient air, indoor air, stack gas, landfill gas, synthetic gas, other) containing trace volatile compounds by GCMS when the list of target compounds includes those that are both less and more volatile than CO₂, related to their ability to be collected on a sorbent trap at specific trapping temperatures. Greenhouse gases have this requirement, as many are lighter than CO₂, while others are heavier. In particular, US EPA Method OTM-50 for the analysis of PFAS/VFC compounds from C1 to C8 in stack gas can substantially benefit from the techniques disclosed herein. Alternative approaches to analyze toxic chemicals in air (EPA method TO-14A, TO-15, TO-15A) must use two separate analyses to measure OTM-50 compounds: one analysis to measure CF4 and another analysis whereby the CF4 and CO₂ are purged off, followed by analysis of the C2 PFAS, C1 VFC, and all heavier compounds. The first analysis is limited to volumes that will not cause over-expansion of the focused gas as CO₂ must be injected into the GC. Techniques disclosed herein eliminate CO₂ while quantitatively recovering all other compounds in OTM-50 at a full volume of 200cc. This enhanced capability reduces the cost per sample analysis by reducing the number of analyses needed and improves the sensitivity of the lightest compound CF4 due to the ability to trap and inject a larger volume of sample gas. The deposition of CO₂ initially into the solid phase allows concentrations of CO₂ to even exceed 4% of the initial sample, or can allow sample volumes larger than 200cc to be analyzed to further improve detection limits. The ability to remove CO₂ can be important for conducting analyses sensitive to CO₂ concentrations as low as 0.1% and/or analyses having detection limits in the low-part-per trillion range, such as analysis of PFAS in ambient or indoor air environments.

Therefore, according to the above, some embodiments are directed to a system comprising: a first primary trap and a second primary trap arranged in series; a focusing trap; one or more valves configured to selectively establish fluid communication between the traps and a gas chromatograph; and a control system configured to operate the one or more valves and control temperatures of the traps to perform a method comprising: directing a sample through the first primary trap and the second primary trap; freezing CO₂ included in the sample on the first primary trap; while retaining frozen CO₂ on the first primary trap, heating the second primary trap to transfer a first portion of target compounds of the sample to the focusing trap; heating the first primary trap to mobilize and remove the CO₂ from the system; heating the first and second primary traps to transfer a second portion of target compounds to the focusing trap; and desorbing the target compounds from the focusing trap into the gas chromatograph. Additionally or alternatively, in some embodiments, the first primary trap comprises a first sorbent and the second primary trap comprises a second sorbent, the second sorbent having a stronger affinity for target compounds of the sample than the first sorbent. Additionally or alternatively, in some embodiments, the system includes a gas volume measurement system fluidly coupled to the one or more valves, wherein the control system is further configured to: direct the CO₂ to the gas volume measurement system; and measure a volume of bulk gases not retained by the first primary trap and second primary trap while directing the sample through the first primary trap and the second primary trap. Additionally or alternatively, in some embodiments, the system includes a water knockout trap; and a heater associated with the water knockout trap configured to maintain the water knockout trap at a temperature between -10° C and -30° C.

Some embodiments are directed to a method for analyzing a sample, the method comprising: directing the sample through a first primary trap and a second primary trap arranged in series in a system while cooling the first primary trap and the second primary trap; freezing CO₂ included in the sample on the first primary trap; while retaining frozen CO₂ on the first primary trap, heating the second primary trap to transfer a first portion of target compounds of the sample to a focusing trap; heating the first primary trap to mobilize and remove the CO₂ from the system; heating the first and second primary traps to transfer a second portion of target compounds to the focusing trap; and desorbing the target compounds from the focusing trap into a gas chromatograph. Additionally or alternatively, in some embodiments, transferring the second portion of the target compounds to the focusing trap includes transferring the second portion of the target compounds through a water knockout trap, and the method further comprises maintaining the water knockout trap at a temperature between -10° C and -30° C during transfer of the first portion of the target compounds. Additionally or alternatively, in some embodiments, the first primary trap comprises a first sorbent and the second primary trap comprises a second sorbent, the second sorbent having a stronger affinity for target compounds of the sample than the first sorbent. Additionally or alternatively, in some embodiments, the method includes comprising directing the CO₂ to a gas volume measurement system to measure a volume of gas during initial trapping, first target compound focusing, CO₂ removal, and second target compound focusing.

Although examples have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system comprising:
a first primary trap and a second primary trap arranged in series;
a focusing trap;
one or more valves configured to selectively establish fluid communication between the traps and a gas chromatograph; and
a control system configured to operate the one or more valves and control temperatures of the traps to perform a method comprising:
directing a sample through the first primary trap and the second primary trap;
freezing CO₂ included in the sample on the first primary trap;
while retaining frozen CO₂ on the first primary trap, heating the second primary trap to transfer a first portion of target compounds of the sample to the focusing trap;
heating the first primary trap to mobilize and remove the CO₂ from the system;
heating the first and second primary traps to transfer a second portion of target compounds to the focusing trap; and
desorbing the target compounds from the focusing trap into the gas chromatograph.

2. The system of claim 1, wherein the first primary trap comprises a first sorbent and the second primary trap comprises a second sorbent, the second sorbent having a stronger affinity for target compounds of the sample than the first sorbent.

3. The system of claim 1, further comprising a gas volume measurement system fluidly coupled to the one or more valves, wherein the control system is further configured to:
direct the CO₂ to the gas volume measurement system; and
measure a volume of bulk gases not retained by the first primary trap and second primary trap while directing the sample through the first primary trap and the second primary trap.

4. The system of claim 1, further comprising:
a water knockout trap; and
a heater associated with the water knockout trap configured to maintain the water knockout trap at a temperature between -10° C and -30° C.

5. A method for analyzing a sample, the method comprising:
directing the sample through a first primary trap and a second primary trap arranged in series in a system while cooling the first primary trap and the second primary trap;
freezing CO₂ included in the sample on the first primary trap;
while retaining frozen CO₂ on the first primary trap, heating the second primary trap to transfer a first portion of target compounds of the sample to a focusing trap;
heating the first primary trap to mobilize and remove the CO₂ from the system;
heating the first and second primary traps to transfer a second portion of target compounds to the focusing trap; and
desorbing the target compounds from the focusing trap into a gas chromatograph.

6. The method of claim 5, wherein transferring the second portion of the target compounds to the focusing trap includes transferring the second portion of the target compounds through a water knockout trap, and the method further comprises maintaining the water knockout trap at a temperature between -10° C and -30° C during transfer of the first portion of the target compounds.

7. The method of claim 5, wherein the first primary trap comprises a first sorbent and the second primary trap comprises a second sorbent, the second sorbent having a stronger affinity for target compounds of the sample than the first sorbent.

8. The method of claim 5, further comprising directing the CO₂ to a gas volume measurement system to measure a volume of gas during initial trapping, first target compound focusing, CO₂ removal, and second target compound focusing.
